(19) United States
(12) Patent Application Publication
(10) Pub. No.: US 2023/0247729 A1
(43) Pub. Date: Aug. 3, 2023

(54) Container Heating Apparatus

(71) Applicant: Brad Alan Granley, Parker, CO (US)

(72) Inventor: Brad Alan Granley, Parker, CO (US)

(21) Appl. No.: 18/159,687

(22) Filed: Jan. 26, 2023

Related U.S. Application Data
(60) Provisional application No. 63/304,017, filed on Jan. 28, 2022.

(51) Int. Cl. H05B 3/34

(52) U.S. Cl. CPC H05B 3/34

(57) ABSTRACT

A container heating apparatus to encompass a container holding a fluid to be heated, the container heating apparatus includes an outer first flexible elastomeric surrounding insulating sidewall that is affixed to a flexible planar heating element that is formed into a second elastomeric surrounding sidewall that is further affixed to an inner third flexible elastomeric surrounding heat conducting sidewall that is placed adjacent to a portion of an outer surface of the container for the operational purpose of heating the fluid in the container.

### CROSS-REFERENCE TO RELATED APPLICATIONS

This application claims the benefit of U.S. provisional patent application Ser. No. 63/304,017 filed on Jan. 28, 2022 by Brad Alan Granley of Parker Colo., U.S.

### BACKGROUND OF THE INVENTION

The present invention is a container heating apparatus to heat lotions, creams, gels, pastes, liquids, or other materials collectively defined as an article being heated that is disposed within a container, wherein the article container is an original container that the article is disposed within for user convenience in that the user does not have to transfer the article to a specialized container for the heating apparatus.

In particular, the process of applying colder lotion to the user's skin, or to that of a child or infant, can be a very uncomfortable experience, especially in the colder seasons of the year. Applying lotion to a user's skin is typically needed more during the colder seasons as the relative atmospheric humidity is lower and can lead to dry, itchy, and cracked skin, so the user would more likely be applying lotion to their skin in the colder seasons, so it would be desirable to have a warmer lotion to apply to the user's skin for comfort. Applying warm lotion is pleasing and relaxing and can be therapeutic for those with various medical conditions (general dryness, itchiness, skin conditions, general stiffness, arthritis, Raynaud's disease, etc.).

Various types of lotion warmers are known in the art. However, they generally include having the requirement of the user transferring a lotion into a cavity or specialized container specific to the lotion warmer which then heats the lotion prior to application of the lotion to the user's skin. It is very inconvenient for the user to change lotion scents without first properly cleaning out the cavity or specialized container prior to filling with a new scent lotion, as it is difficult to remove all of the lotion that can be pumped from the cavity or specialized container that results in wasted lotion, as well as a net detriment to the environment (due to wasted lotion and containers). The act of transferring lotion in and of itself discourages use and at best makes it difficult to change to a new scent when one runs out (or to simply change scents at any time when desired), and at worst typically results in existing lotion warmers being set aside and not used (people typically don't desire to clean anything out).

Also, some lotion warmers end up clogging or otherwise failing in relation to the cavity or specialized container pump requiring additional cleaning, possibly needing a replacement pump unique to the lotion warmer. Further the prior art lotion warmers that require the lotion to be put in its cavity or specialized container are of necessity larger, heavier, and bulkier, as compared to the present invention lotion warmer that is flat foldable apparatus being much more portable and compact.

### PRIOR ART

Looking at the prior art in this area starting with United States patent application Publication number 2021/0077294 to Mandal that has not been examined yet at the Patent Office teaches a stretchable medical body heating tape that is constructed of a woven in fabric heating element with a claimed 100% stretch allowable, having an adhesive on one side for removably adhering to the skin, that can be run on batteries and be rechargeable. Note that on Mandal, heat transfer efficiency is not a major concern, i.e. holding heat or heat loss from the apparatus as it only puts heat onto the skin as opposed to the lotion warmer that has desires of holding heat to the lotion container as efficiently as possible.

Continuing, in U.S. Pat. No. 11,465,364 to Augustine teaches a hospital patient heating pad that claims 3-D flexibility but is really mainly highly bendable with emphasis upon the fabric layer properties for medical reasons, Augustine does have a unique heating element 310 that is a flexible sheet that is in electrical communication with a series of bus bars 315 via electrically conductive stitching thread 345, see FIGS. 2A/B, Further, Augustine includes insulation 318 to prevent heating element failure in the event of the conductive stitching failing in places. This is a close reference in the field of specialty heating elements for flexibility plus being a recently approved patent (just last month), however, noting that stretching is not taught, nor did any electrical heating elements show up in the keyword search for “stretching” with electrical heating element as a search term.

Next, in United States Patent Application Publication Number 2004/0217110 to Gray, had never made it to a patent due to insufficient disclosure surrounding the flexible and stretchable heating element. Gray teaches a heating blanket that includes a body to generate heat from power supplied by two leads. The body in Gray includes a heating element coupled to a stretchable matt, when the matt is stretched, the heating element stretches in the same direction and can continue to generate heat. Consequently, the body in Gray of the heating blanket can maintain sufficient contact with a composite assembly as a contour of the composite assembly's surface changes, and the blanket can adequately cure the composite in regions of an assembly that would otherwise be difficult to cure.

Further, in United States patent application Publication number 2022/0312863 to Desmeules, that has not been examined yet at the Patent Office, teaches a typical heated sock that operates on rechargeable batteries, that show the bendable but not stretchable heat element in the toe cap, as heating element 50 that has a series on cantilever extensions originating from a common base like “fingers” over the toes, so this is an example of intermittent heat element placement in a flexible fabric. The difference to the lotion warmer is that there is a needed stretchability throughout the fabric panel, and on the toe covering for the sock-stretch only need to be a one end, i.e. the tips of the toes. Desmeules has no teaching specific to unique heat element properties.

Continuing, in United States patent application Publication number 2022/0201805 to Bienvenu, that has not been examined yet at the Patent Office, teaches a flexible and stretchable electrical heating mat for the temperature treatment of complex shaped parts via the mat conforming to the outer surface of the part. For the heating element in Bienvenu the novel double flex cavity with a serpentine shape that allows flexure within for a zig-zag heating element up to a 90-degree bend and doubling of the stretch length. This is a good example of novel heating element design for flexing and stretching.

Next, United States patent application Publication number 2020/0263334 to Mueller, that has an open office action currently that is partially rejected against some of this same inventors prior art at the Patent Office, wherein Mueller teaches a knitted spacer fabric that has a first warp-knitted layer having stitching running in a production direction and rows of stitches extending in a transverse direction, a second warp-knitted layer also having stitching running in a production direction, and rows of stitches extending in a transverse direction, wherein the layers are connected. One of the knitted layers in Mueller is composed of nonconductive yarns and conductive yarns, the conductive yarns are incorporated into the one knitted layer, the conductive yarn can be zig-zag with serpentine pattern being for car seat heating, wherein optimum heat transfer and retention are not major concerns in Mueller.

Moving onward, in United States patent application Publication number 2020/0128627 to Lamontia, that was approved but was abandoned as the Applicant failed to fix some minor style issues at the Patent Office, this teaches an apparatus containing a heater including a substrate, two parallel printed bus bars, and an array of printed heating resistive material areas with uniform thickness arranged along a series of regular zigzags between the two bus bars, providing stretchability in all directions.

Further, in U.S. Pat. No. 10,729,620 to Goodin, is included to show an example of bottle bottom heating, this reference also includes an agitator with the heating element only on the bottom of the heater.

Continuing, in United States patent application Publication number 2004/0217102 that matured into U.S. Pat. No. 6,921,880 to Berger, in looking at the dossier, patentability was in the fingered stretching heating element that includes a panel of expandable material, with a plurality of heating elements each with a free end attached to the expandable material, and having a means for interconnecting the heating element to a power supply, wherein functionally the expandable material closely conforming to the outer surface of a vessel for warming the contents therein. Other features in Berger include that the expandable material is a layer of polyester and a layer of neoprene, the plurality of heating elements are of a cantilever construction with each having a free tapered end and an attached end on a common electrical buss.

In Berger, there is no in-depth teaching on any heat transfer enhancements such as special heating elements or heating element configurations or even the issue of transfer of heat to the expandable material or the vessel itself. In fact Berger teaches against heating element “stretch” by admitting that the heating element material has no elasticity, so in summary Berger has no specific teaching especially in heat transfer technology, also note that this patent is almost twenty years old, so there have been advances in general heat transfer technology in this area that would supersede Berger's teaching, for example bottom vessel heating (to take advantage of convection) and top vessel insulation (to slow down vessel top heat loss due to convection).

Next, in U.S. Pat. No. 6,870,135 to Hamm, is an open ended frustro-conical heating jacket structure—very similar to the common used insulation sleeve on paper coffee cups (otherwise nothing special)—this case had the weakest case for patentability. With both ends open in Hamm, this sleeve would be very inefficient heat transfer wise by not taking advantage of convention from the cup bottom and excessive loss of heat out of the top of the cup, flexible insulating material of the sleeve is only taught in the most generic of terms, nothing specific, again, note that this patent is almost twenty years old, so there have been advances in general heat transfer technology in this area.

Continuing, in United States Patent Application Publication Number 2006/0157471 to Taylor, this was approved for patent but abandoned due to corrected drawings not being submitted, novelty was in the securing connection of the receptacle according to the dossier. Taylor resembles a napkin holder in shape with heating in resistance, microwave, wax, gel, and oil are suggested, however, with none of these heating types was there any specific teaching as to how to actually make and use these different heating systems. As in Hamm, Taylor would be very inefficient heat transfer wise by not taking advantage of convection from the container bottom and excessive loss of heat out of the top of the container, via only vertically heating the sides of the container. Again, note that this application is almost twenty years old, so there have been advances in general heat transfer technology in this area that would supersede Taylor's teaching

What is needed in the present invention of the container heating apparatus, is a “warming wrap” or slide over type approach rather than the prior art lotion heater container transfer procedure that required using the dedicated lotion heater cavity or specialized container, wherein the “warming wrap” or slide over utilized the original lotion container removing the need for the user to transfer the lotion from the original container to the lotion heater cavity or specialized container thus resulting in having warm lotion easily accessible in its original container. To use the present invention of the container heating apparatus the user needs to simply wrap the apparatus around most any sized original bottle of lotion and it is warmed to a preferred temperature via an on/off switch.

As an optional embodiment the apparatus can be programmed via a phone app or the apparatus interface to heat lotion to a selected user temperature during specific time periods, or the apparatus may be kept in the on state continuously based on the user's preference. The user can easily remove the “warming wrap” from the original lotion bottle and put it around another original lotion bottle if the previous original lotion bottle is empty or if a different scent or type of lotion is desired at any time. No original lotion bottle cleaning or messy lotion transfer is ever required since the lotion is warmed in its original bottle. The outer layer of the apparatus can be creatively decorated in infinite ways to be aesthetically pleasing and appealing to any age or demographic. The materials of construction of the apparatus are heat trapping to minimize energy use and reduce a user's carbon footprint in a small, but incremental way. The apparatus can be powered by a USB connected to a wall or other power source.

### SUMMARY OF THE INVENTION

Broadly the present invention is the container heating apparatus to encompass a container with a container outer surface and an opposing container inner surface that defines a container interior, the container outer surface also having an outer surface perimeter, with a fluid disposed therein the container interior, wherein the fluid is heated.

The container heating apparatus includes a first flexible elastomeric surrounding sidewall that is about a longitudinal axis, the first flexible elastomeric surrounding sidewall having a first primary end portion and an opposing first secondary end portion with the longitudinal axis spanning therebetween, the first flexible elastomeric surrounding sidewall further including a first inner surface and an opposing first outer surface.

Further included in the container heating apparatus is a flexible planar heating element being formed into a second elastomeric surrounding sidewall that is about a lengthwise axis, the second flexible elastomeric surrounding sidewall having a second primary end portion and an opposing second secondary end portion with the lengthwise axis spanning therebetween. The second flexible elastomeric surrounding sidewall further including a second inner surface and an opposing second outer surface, wherein the second outer surface is affixed to the first inner surface with the longitudinal and the lengthwise axes being coincident to one another.

Also included in the container heating apparatus is a third flexible elastomeric surrounding sidewall that is about a longwise axis, the third flexible elastomeric surrounding sidewall having a third primary end portion and an opposing third secondary end portion with the longwise axis spanning therebetween. The third flexible elastomeric surrounding sidewall further including a third inner surface and an opposing third outer surface, wherein the third outer surface is affixed to the second inner surface with the longwise and the lengthwise axes being coincident to one another such that the first, second, and third elastomeric surrounding sidewalls form the container heating apparatus. Wherein operationally the third inner surface is placed adjacent to a portion of the container outer surface wherein the third inner surface is manually positioned to partially encompass a portion of the container outer surface.

### BRIEF DESCRIPTION OF DRAWINGS

FIG. 1 shows an upper perspective view of the container heating apparatus that includes showing first the first flexible elastomeric surrounding sidewall, the flexible planar heating element forming the second flexible elastomeric surrounding sidewall, and the third flexible elastomeric surrounding sidewall with the respective longitudinal, lengthwise, and longwise axes.

FIG. 2 shows an upper perspective view of the container heating apparatus that is an opposing view of FIG. 1, wherein FIG. 2 shows first the second means for removable engagement in the form of a hook and loop fastener that is affixed to the inner surface of the third flexible elastomeric surrounding sidewall and then subsequently the second flexible elastomeric surrounding sidewall and the first flexible elastomeric surrounding sidewall.

FIG. 3 shows an upper perspective view of the alternative embodiment of the container heating apparatus that includes showing first the flexible elastomeric surrounding sidewall cover, then the first flexible elastomeric surrounding sidewall, next the reflective flexible elastomeric surrounding sidewall, further the flexible planar heating element forming the second flexible elastomeric surrounding sidewall, and the third flexible elastomeric surrounding sidewall with the respective longways, longitudinal, lengthways, lengthwise, and longwise axes.

FIG. 4 shows an upper perspective view of the alternative embodiment of the container heating apparatus that is an opposing view of FIG. 3, wherein FIG. 4 shows first the second means for removable engagement in the form of a hook and loop fastener that is affixed to the inner surface of the third flexible elastomeric surrounding sidewall and then subsequently the second flexible elastomeric surrounding sidewall, then the reflective flexible elastomeric surrounding sidewall, next the first flexible elastomeric surrounding sidewall and the flexible elastomeric surrounding sidewall cover.

FIG. 5 shows an exploded upper perspective view of the container heating apparatus that includes showing first the first flexible elastomeric surrounding sidewall, the flexible planar heating element forming the second flexible elastomeric surrounding sidewall, and the third flexible elastomeric surrounding sidewall with the respective longitudinal, lengthwise, and longwise axes.

FIG. 6 shows an exploded upper perspective view of the alternative embodiment of the container heating apparatus that includes showing first the flexible elastomeric surrounding sidewall cover, then the first flexible elastomeric surrounding sidewall, next the reflective flexible elastomeric surrounding sidewall, further the flexible planar heating element forming the second flexible elastomeric surrounding sidewall, and the third flexible elastomeric surrounding sidewall with the respective longways, longitudinal, lengthways, lengthwise, and longwise axes.

FIG. 7 shows an upper perspective view of the container heating apparatus or the alternative embodiment in an installing use view with the inner surface of the third flexible elastomeric surrounding sidewall and the second means for removable engagement in the form of a hook and loop fastener being initially placed adjacent to the container outer surface, wherein also shown is the container inner surface with the fluid disposed therein and the container outer surface perimeter that can vary with different size containers.

FIG. 8 shows an upper perspective view of the container heating apparatus or the alternative embodiment in a completely installed use view with the inner surface of the third flexible elastomeric surrounding sidewall encompassing a portion of the container outer surface and then using the first and second means for removable engagement in the form of a hook and loop fastener being removably engaged to one another to removably secure the third flexible elastomeric surrounding sidewall and therefore the container heating apparatus or the alternative embodiment to the portion of the container outer surface, also shown is the container alone for comparison being of a top discharge plunger pump type.

FIG. 9 shows an upper perspective view of the container heating apparatus or the alternative embodiment in a completely installed use view with the inner surface of the third flexible elastomeric surrounding sidewall encompassing a portion of the container outer surface and then using the first and second means for removable engagement in the form of a hook and loop fastener being removably engaged to one another to removably secure the third flexible elastomeric surrounding sidewall and therefore the container heating apparatus or the alternative embodiment to the portion of the container outer surface, also shown is the container alone for comparison being of a bottom discharge squeeze type.

FIG. 10 shows an upper perspective telescoping view of the container heating apparatus to more clearly show the nesting nature of the first flexible elastomeric surrounding sidewall being affixed to the flexible planar heating element forming the second flexible elastomeric surrounding sidewall being affixed to the third flexible elastomeric surrounding sidewall with the respective longitudinal, lengthwise, and longwise axes being coincident to one another.

FIG. 11 shows an upper perspective telescoping view of the alternative embodiment of the container heating apparatus to more clearly show the nesting nature of the first the flexible elastomeric surrounding sidewall cover being affixed to the first flexible elastomeric surrounding sidewall being affixed to the reflective flexible elastomeric surrounding sidewall being affixed to the flexible planar heating element forming the second flexible elastomeric surrounding sidewall being affixed to the third flexible elastomeric surrounding sidewall with the respective longways, longitudinal, lengthways, lengthwise, and longwise axes being coincident to one another.

FIG. 12 shows an upper perspective view of the container heating apparatus to more clearly show the unwrapped semi-open nature of the first flexible elastomeric surrounding sidewall being affixed to the flexible planar heating element forming the second flexible elastomeric surrounding sidewall being affixed to the third flexible elastomeric surrounding sidewall with the respective longitudinal, lengthwise, and longwise axes being coincident to one another, further the first and second means for removable engagement in the form of a hook and loop fastener that respectively for the first and second strips that are positioned to removably engage to one another to wrap the container heating apparatus about the container (not shown).

FIG. 13 shows an upper perspective of the alternative embodiment of the container heating apparatus to more clearly show the unwrapped semi-open nature of the the flexible elastomeric surrounding sidewall cover being affixed to the first flexible elastomeric surrounding sidewall being affixed to the reflective flexible elastomeric surrounding sidewall being affixed to the flexible planar heating element forming the second flexible elastomeric surrounding sidewall being affixed to the third flexible elastomeric surrounding sidewall with the respective longways, longitudinal, lengthways, lengthwise, and longwise axes being coincident to one another, further the first and second means for removable engagement in the form of a hook and loop fastener that respectively for the first and second strips that are positioned to removably engage to one another to wrap the alternative embodiment of the container heating apparatus about the container (not shown).

FIG. 14 shows cross section 14-14 from FIGS. 12 and 13, wherein FIG. 14 shows the second means for removable engagement in the form of the hook and loop fastener that has the second strip that is disposed within a recessed channel in the third inner surface to form a first plane such that the second strip does not protrude beyond the third inner surface to increase heat transfer from the third inner surface to the container outer surface.

### DETAILED DESCRIPTION OF THE INVENTION

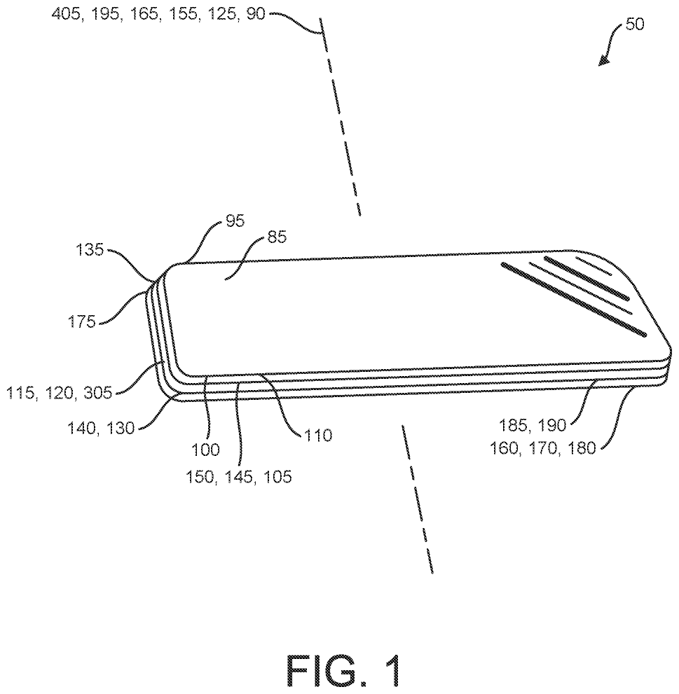

Looking at FIG. 1 initially shows an upper perspective view of the container heating apparatus 50 that includes showing first the first flexible elastomeric surrounding sidewall 85, the flexible planar heating element 115 forming the second flexible elastomeric surrounding sidewall 120, and the third flexible elastomeric surrounding sidewall 160 with the respective longitudinal 90, lengthwise 125, and longwise 165 axes.

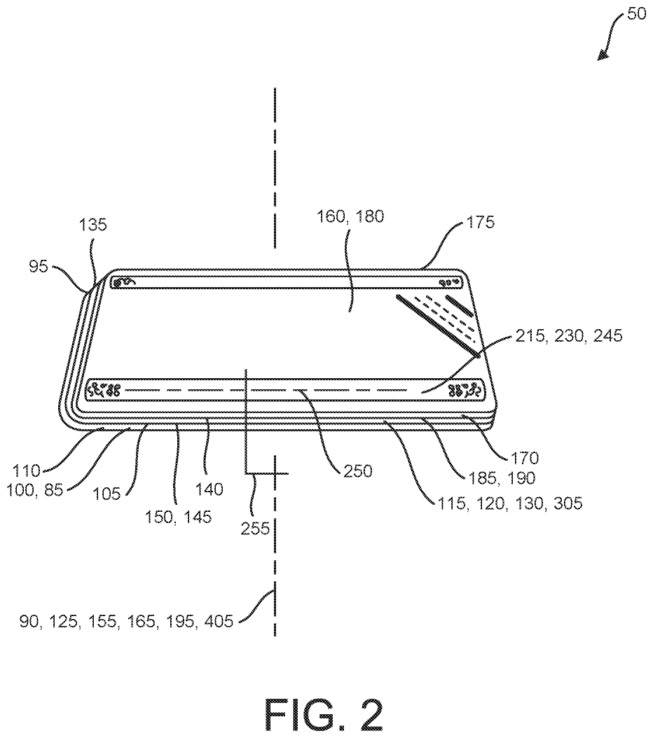

Moving onward to FIG. 2 shown is an upper perspective view of the container heating apparatus 50 that is an opposing view of FIG. 1, wherein FIG. 2 shows first the second means 215 for removable engagement in the form of a hook and loop fastener 230 that is affixed to the inner surface 180 of the third flexible elastomeric surrounding sidewall 160 and then subsequently the second flexible elastomeric surrounding sidewall 120 and the first flexible elastomeric surrounding sidewall 85.

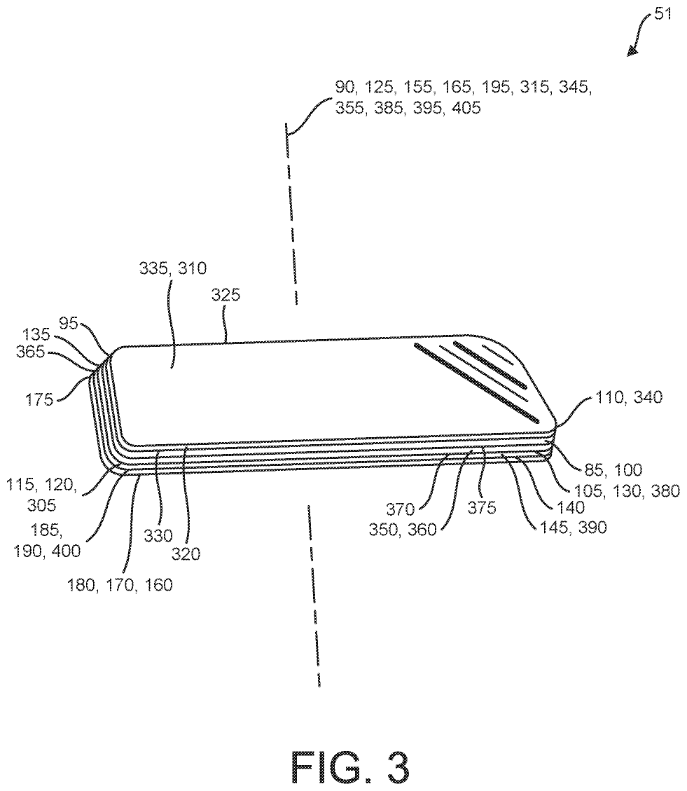

Continuing to FIG. 3 shown is an upper perspective view of the alternative embodiment of the container heating apparatus 51 that includes showing first the flexible elastomeric surrounding sidewall cover 310, then the first flexible elastomeric surrounding sidewall 85, next the reflective flexible elastomeric surrounding sidewall 350, further the flexible planar heating element 115 forming the second flexible elastomeric surrounding sidewall 120, and the third flexible elastomeric surrounding sidewall 160 with the respective longways 315, longitudinal 90, lengthways 355, lengthwise 125, and longwise 165 axes.

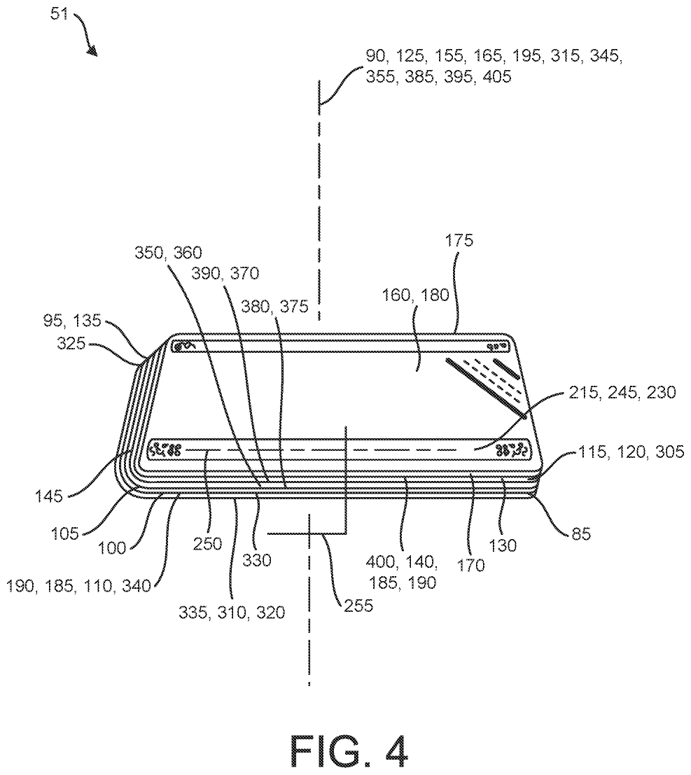

Further, in FIG. 4 shown is an upper perspective view of the alternative embodiment of the container heating apparatus 51 that is an opposing view of FIG. 3, wherein FIG. 4 shows first the second means 215 for removable engagement in the form of a hook and loop fastener 230 that is affixed to the inner surface 180 of the third flexible elastomeric surrounding sidewall 160 and then subsequently the second flexible elastomeric surrounding sidewall 120, then the reflective flexible elastomeric surrounding sidewall 350, next the first flexible elastomeric surrounding sidewall 85, and the flexible elastomeric surrounding sidewall cover 310.

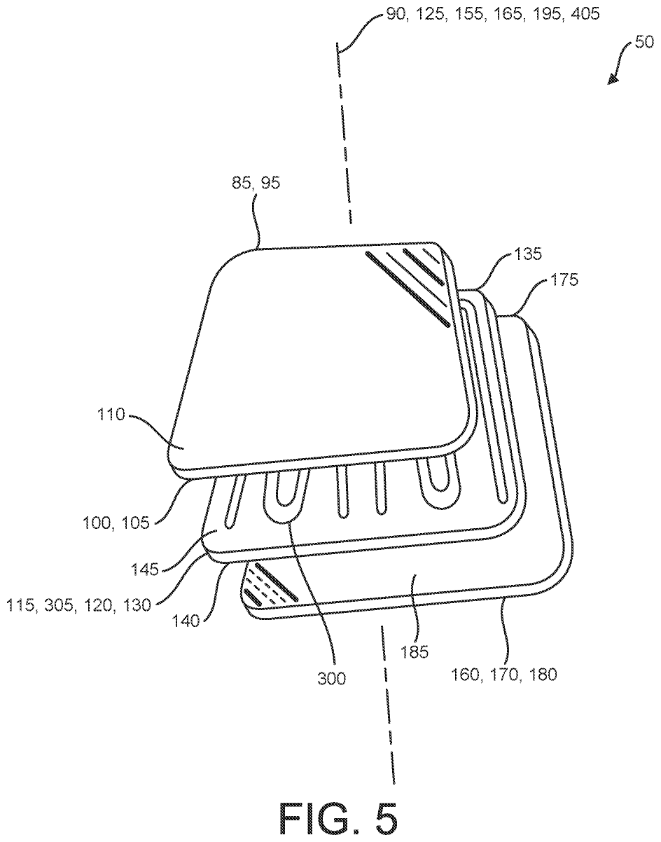

Next, in FIG. 5 initially shown is an exploded upper perspective view of the container heating apparatus 50 that includes showing first the first flexible elastomeric surrounding sidewall 85, the flexible planar heating element 115 forming the second flexible elastomeric surrounding sidewall 120, and the third flexible elastomeric surrounding sidewall 160 with the respective longitudinal 90, lengthwise 125, and longwise 165 axes.

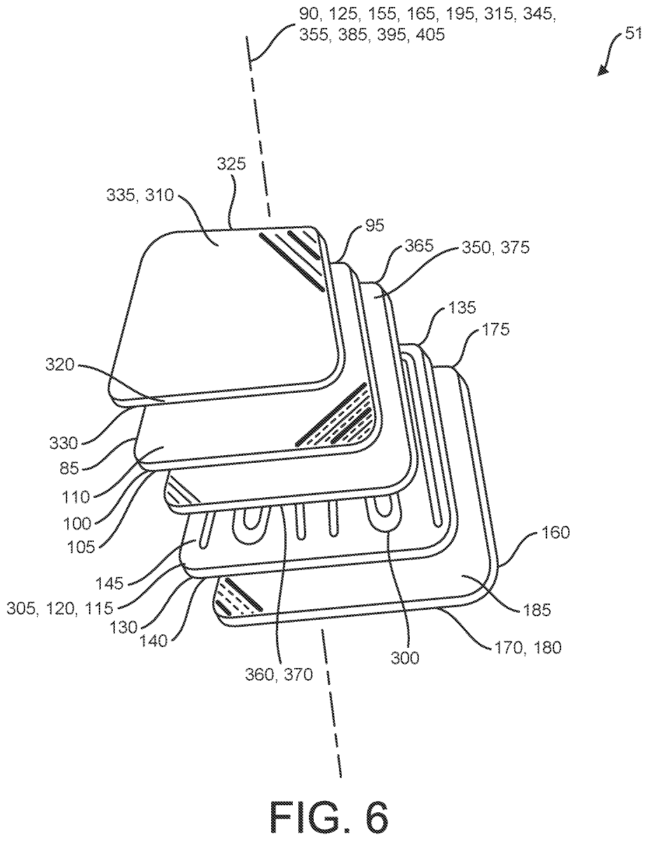

Continuing in FIG. 6 shown is an upper exploded perspective view of the alternative embodiment of the container heating apparatus 51 that includes showing first the flexible elastomeric surrounding sidewall cover 310, then the first flexible elastomeric surrounding sidewall 85, next the reflective flexible elastomeric surrounding sidewall 350, further the flexible planar heating element 115 forming the second flexible elastomeric surrounding sidewall 120, and the third flexible elastomeric surrounding sidewall 160 with the respective longways 315, longitudinal 90, lengthways 355, lengthwise 125, and longwise 165 axes.

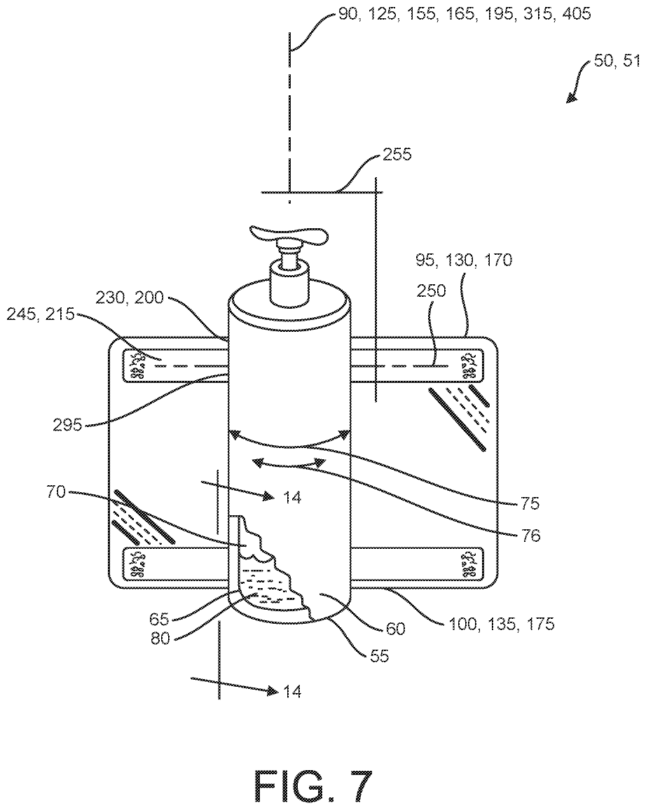

Moving onward, FIG. 7 shows an upper perspective view of the container heating apparatus 50 or the alternative embodiment 51 in an installing use view with the inner surface 180 of the third flexible elastomeric surrounding sidewall 160 and the second means 215 for removable engagement in the form of a hook and loop fastener 230 being initially placed adjacent to the container 55 outer surface 60, wherein also shown is the container 55 inner surface 65 with the fluid 80 disposed therein and the container 55 outer surface 60 perimeter 75 that can vary 76 with different size containers 55.

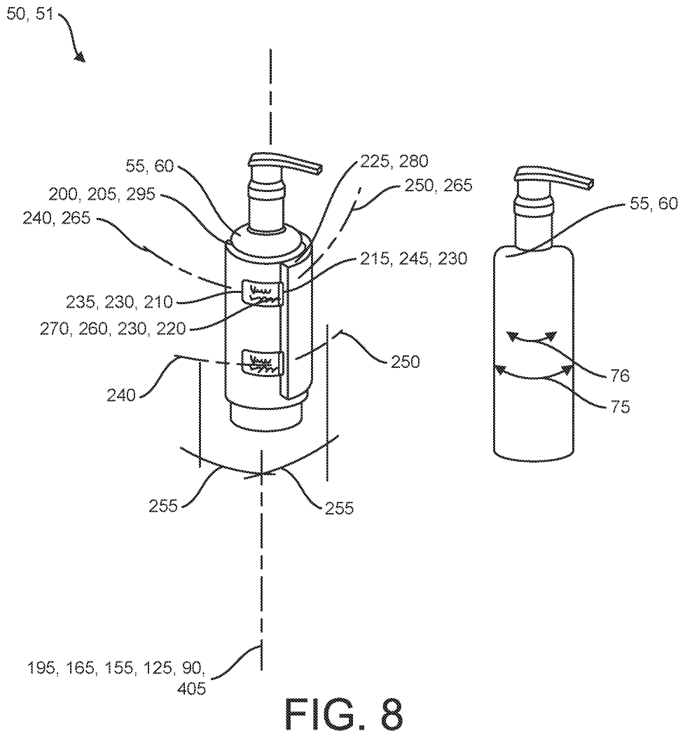

Further, FIG. 8 shows an upper perspective view of the container heating apparatus 50 or the alternative embodiment 51 in a completely installed use view with the inner surface 180 of the third flexible elastomeric surrounding sidewall 160 encompassing a portion of the container 55 outer surface 60 and then using the first 210 and second 215 means for removable engagement in the form of a hook and loop fastener 230 being removably engaged 260, 270, 220 to one another to removably secure the third flexible elastomeric surrounding sidewall 160 and therefore the container heating apparatus 50 or the alternative embodiment 51 to the portion of the container 55 outer surface 60, also shown is the container 55 alone for comparison being of a top discharge plunger pump type.

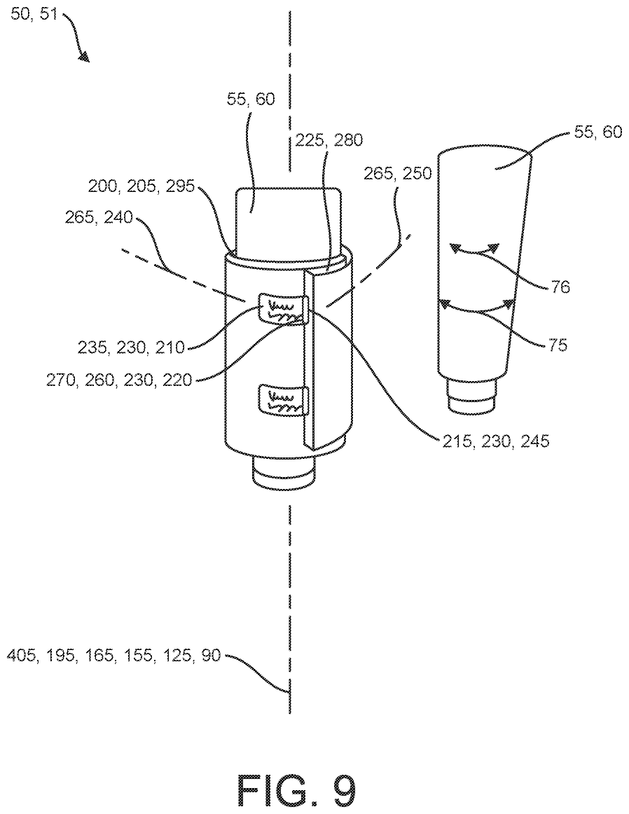

Next, FIG. 9 shows an upper perspective view of the container heating apparatus 50 or the alternative embodiment 51 in a completely installed use view with the inner surface 180 of the third flexible elastomeric surrounding sidewall 160 encompassing a portion of the container 55 outer surface 60 and then using the first 210 and second 215 means for removable engagement in the form of a hook and loop fastener 230 being removably engaged 260, 270, 220 to one another to removably secure the third flexible elastomeric surrounding sidewall 160 and therefore the container heating apparatus 50 or the alternative embodiment 51 to the portion of the container 55 outer surface 60, also shown is the container 55 alone for comparison being of a bottom discharge squeeze type.

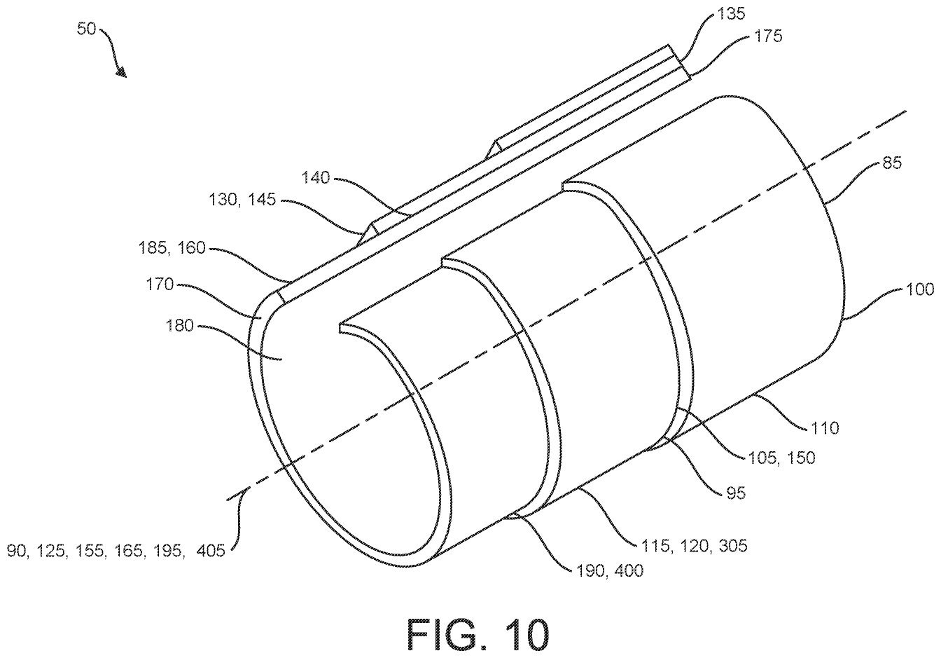

Continuing, FIG. 10 shows an upper perspective telescoping view of the container heating apparatus 50 to more clearly show the nesting nature of the first flexible elastomeric surrounding sidewall 85 being affixed 150 to the flexible planar heating element 115 forming the second flexible elastomeric surrounding sidewall 120 being affixed 190 to the third flexible elastomeric surrounding sidewall 160 with the respective longitudinal 90, lengthwise 125, and longwise 165 axes being coincident 155, 195, 405 to one another.

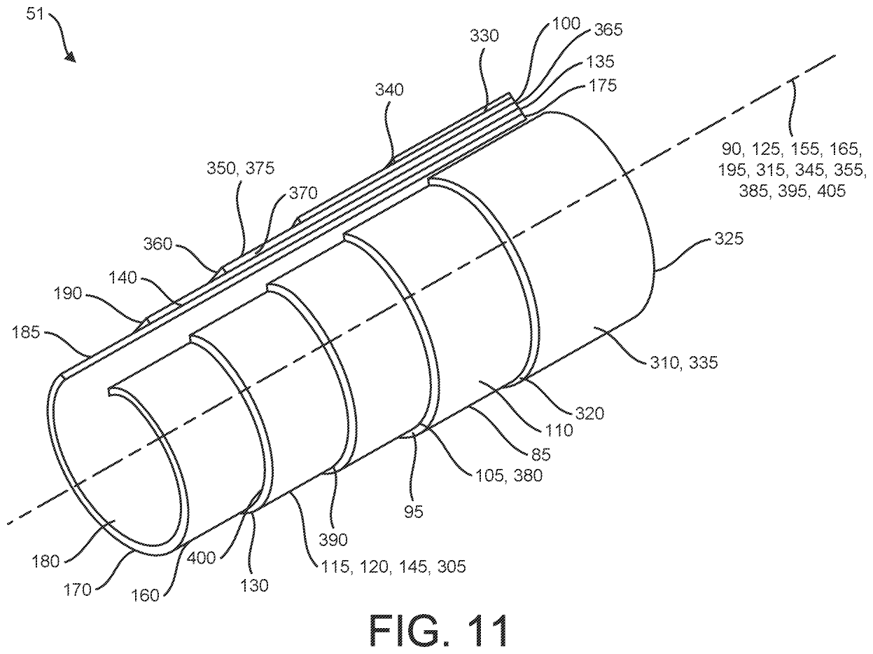

Further, FIG. 11 shows an upper perspective telescoping view of the alternative embodiment 51 of the container heating apparatus to more clearly show the nesting nature of the first the flexible elastomeric surrounding sidewall cover 310 being affixed 340 to the first flexible elastomeric surrounding sidewall 85 being affixed 380 to the reflective flexible elastomeric surrounding sidewall 350 being affixed 390 to the flexible planar heating element 115 forming the second flexible elastomeric surrounding sidewall 120 being affixed 190 to the third flexible elastomeric surrounding sidewall 160 with the respective longways 315, longitudinal 90, lengthways 355, lengthwise 125, and longwise 165 axes being coincident 155, 195, 345, 385, 395, 405 to one another.

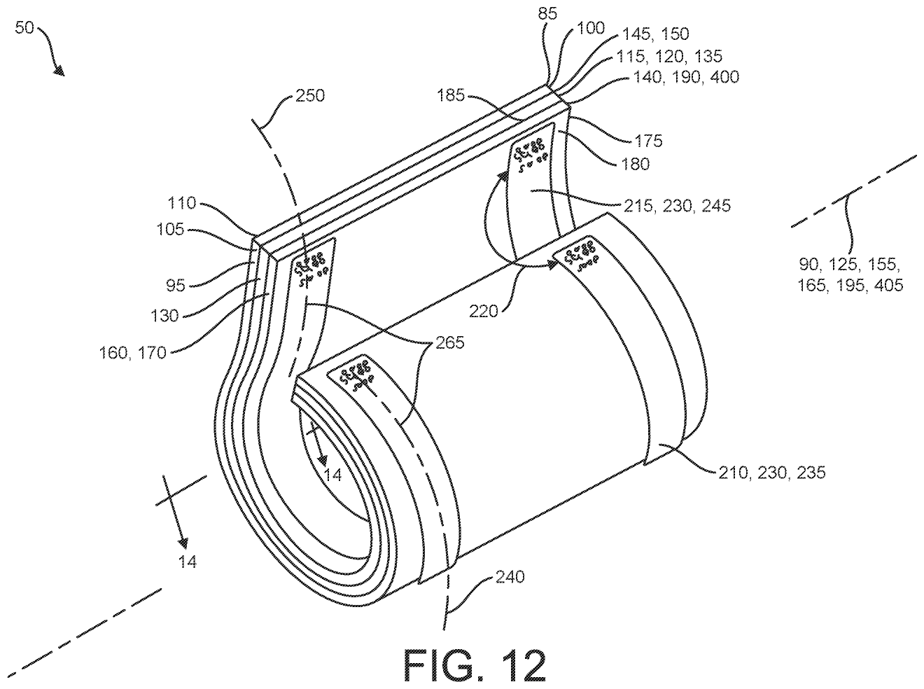

Next, FIG. 12 shows an upper perspective view of the container heating apparatus 50 to more clearly show the unwrapped semi-open nature of the first flexible elastomeric surrounding sidewall 85 being affixed 150 to the flexible planar heating element 115 forming the second flexible elastomeric surrounding sidewall 120 being affixed 190 to the third flexible elastomeric surrounding sidewall 160 with the respective longitudinal 90, lengthwise 125, and longwise 165 axes being coincident 155, 195, 405 to one another. Further the first 210 and second 215 means for removable engagement in the form of a hook and loop fastener 230 that respectively for the first 235 and second 245 strips that are positioned to removably engage 260 to one another to wrap the container heating apparatus 50 about the container 55 (not shown).

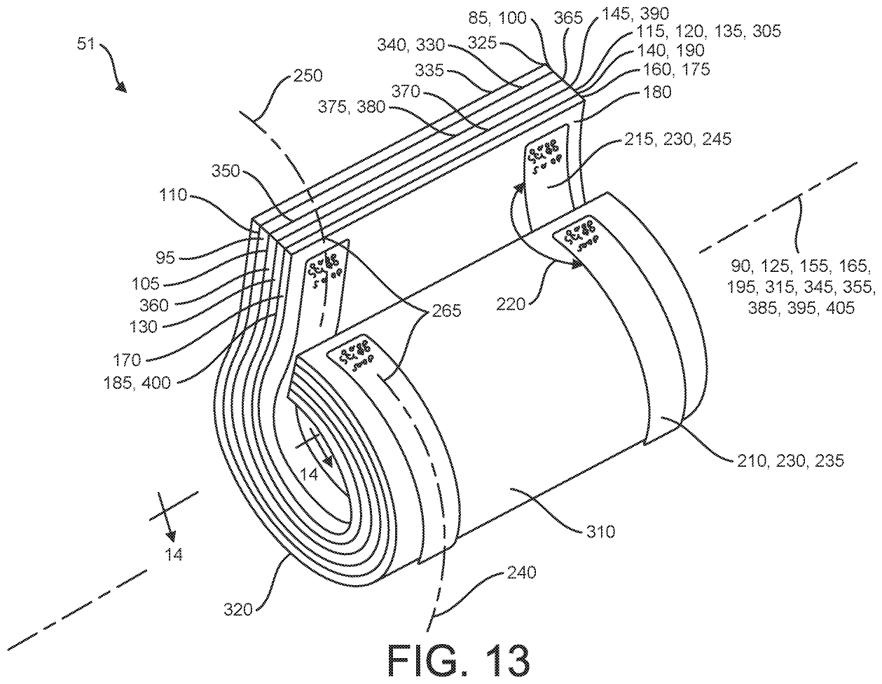

Continuing, FIG. 13 shows an upper perspective of the alternative embodiment 51 of the container heating apparatus to more clearly show the unwrapped semi-open nature of the flexible elastomeric surrounding sidewall cover 310 being affixed 340 to the first flexible elastomeric surrounding sidewall 85 being affixed 380 to the reflective flexible elastomeric surrounding sidewall 350 being affixed 390 to the flexible planar heating element 115 forming the second flexible elastomeric surrounding sidewall 120 being affixed 190 to the third flexible elastomeric surrounding sidewall 160 with the respective longways 315, longitudinal 90, lengthways 355, lengthwise 125, and longwise 165 axes being coincident 155, 195, 345, 385, 395, 405 to one another. Further the first 210 and second 215 means for removable engagement in the form of a hook and loop fastener 230 that respectively for the first 235 and second 245 strips that are positioned to removably engage 260 to one another to wrap the alternative embodiment of the container heating apparatus 51 about the container 55 (not shown).

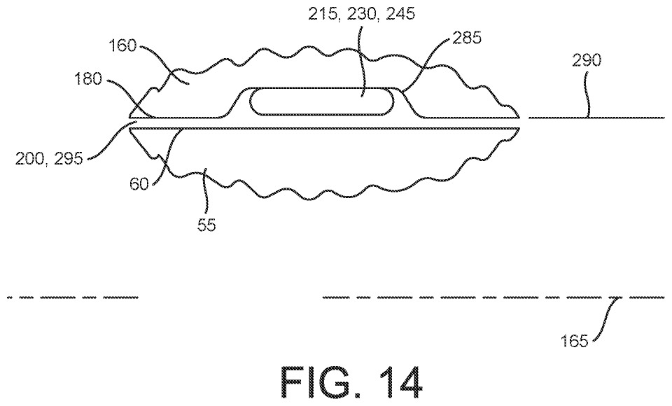

Next, FIG. 14 shows cross section 14-14 from FIGS. 12 and 13, wherein Figure shows the second means 215 for removable engagement in the form of the hook and loop fastener 230 that has the second strip 245 that is disposed within a recessed channel 285 in the third inner surface 180 to form a first plane 290 such that the second strip 245 does not protrude beyond the third inner surface 180 to increase heat transfer from the third inner surface 180 to the container outer surface 60.

Broadly in looking at FIGS. 1, 2, 5, 7-10, 12, and 14, the present invention is the container heating apparatus 50 to encompass the container 55 with a container 55 outer surface 60 and an opposing container 55 inner surface 65 that defines a container 55 interior 70, the container 55 outer surface 60 also having an outer surface 60 perimeter 75, with the fluid 80 disposed therein the container interior 70, wherein the fluid 80 is heated.

The container heating apparatus 50 includes the first flexible elastomeric surrounding sidewall 85 that is about the longitudinal axis 90, the first flexible elastomeric surrounding sidewall 85 having a first primary end portion 95 and an opposing first secondary end portion 100 with the longitudinal axis 90 spanning therebetween, the first flexible elastomeric surrounding sidewall 85 further including a first inner surface 105 and an opposing first outer surface 110.

Further included in the container heating apparatus 50 is a flexible planar heating element 115 being formed into the second elastomeric surrounding sidewall 120 that is about the lengthwise axis 125, the second flexible elastomeric surrounding sidewall 120 having a second primary end portion 130 and an opposing second secondary end portion 135 with the lengthwise axis 125 spanning therebetween. The second flexible elastomeric surrounding sidewall 120 further including a second inner surface 140 and an opposing second outer surface 145, wherein the second outer surface 145 is affixed 150 to the first inner surface 105 with the longitudinal 90 and the lengthwise 125 axes being coincident 155 to one another.

Also included in the container heating apparatus 50 is the third flexible elastomeric surrounding sidewall 160 that is about the longwise axis 165, the third flexible elastomeric surrounding sidewall 160 having a third primary end portion 170 and an opposing third secondary end portion 175 with the longwise axis 165 spanning therebetween. The third flexible elastomeric surrounding sidewall 160 further including the third inner surface 180 and the opposing third outer surface 185, wherein the third outer surface 185 is affixed 190 to the second inner surface 140 with the longwise 165 and the lengthwise 125 axes being coincident 195 to one another such that the first 85, second 120, and third 160 elastomeric surrounding sidewalls form the container heating apparatus 50. Wherein operationally the third inner surface 180 is placed adjacent 200 to a portion of the container 55 outer surface 60 wherein the third inner surface 180 is manually positioned to partially encompass 205 a portion of the container 55 outer surface 60, see in particular FIGS. 7-9, 12, and 13.

As an option for the container heating apparatus 50, the first outer surface 110 can further comprise the first means 210 for removable engagement and the third inner surface 180 further comprises the second means 215 for removable engagement, wherein the first 210 and second 215 means for removable engagement are removably mated 220 to one another to facilitate a partial overlap 225 of the third inner surface 180 in relation to the first outer surface 110 to facilitate the container heating apparatus 50 to partially encompass 205 the container outer surface 60, see FIGS. 7-9, 12, and 13.

A further option for the container heating apparatus 50, the first 210 and second 215 means for removable engagement are both constructed of a hook and loop fastener 230 in the form of a first strip 235 for the first means 210 for removable engagement and a second strip 245 for the second means 215 for removable engagement, wherein the first strip 235 has a first elongated axis 240 and the second strip 245 has a second elongated axis 250. Wherein the first 240 and second 250 elongated axes are both substantially perpendicular 255 to the longwise axis 165. Thus, operationally the first 235 and second 245 strips removably engage 260 one another such that the first 240 and second 250 elongated axes are substantially co-incident 265 to one another however, allowing selectable engagement 270 of the first 235 and second 245 strips along the first 240 and second 250 elongated axes to operationally accommodate a variable perimeter 76 of the container 55 outer surface 60 perimeter 75 to result in the third inner surface 180 being fully adjacent 295 to the container outer surface 60 with a variable overlap 280 of the third inner surface 180 on top of the first outer surface 110.

Another option for the container heating apparatus 50 or the alternative embodiment 51, is that the third inner surface 180 can further comprise a recessed channel 285 that is adapted to receive the second strip 245 such that a substantially flat first plane 290 is formed across both the third inner surface 180 and the second strip 245 to operationally facilitate the third inner surface 180 to fully contact 295 the container 55 outer surface 60 adjacent to the second strip 245 to increase heat transfer from the flexible planar heating element 50 to the container 55 outer surface 60, see FIG. 14 in particular.

A continuing option for the container heating apparatus 50 or the alternative embodiment 51, the flexible planar heating element 115 is preferably constructed of a serpentine electrical resistance heating element 300 that is supported by a flexible backing sheet 305 to form the second elastomeric surrounding sidewall 120, see FIGS. 5 and 6. The serpentine electrical resistance heating element 300 can utilize electrical power from standard household electrical power typically being 110 VAC at any frequency or rechargeable battery electrical power that can be 5-48 VDC or equivalents.

Another option for the container heating apparatus 50 or the alternative embodiment 51, the first flexible elastomeric surrounding sidewall 85 is preferably constructed of a flexible thermally insulative material that is selected from the group consisting of open cell foam, closed cell foam, air pocket sheeting, fleece, silicone, ceramic fiber, polyester, nylon, cotton, muslin, rubber, butyl, wool, fiberglass, and synthetic fiber.

A next option for the container heating apparatus 50 or the alternative embodiment 51, the third flexible elastomeric surrounding sidewall 160 is preferably constructed of a flexible thermally conductive material that is selected from the group consisting of metal mesh fabrics, metalized weaving yarns, flexible metals, graphene prints, and graphite film.

Broadly in looking at FIGS. 3, 4, 6-9, 11, 13, and 14, the present invention of the alternative embodiment 51 of the container heating apparatus to encompass the container 55 with a container 55 outer surface 60 and an opposing container 55 inner surface 65 that defines a container 55 interior 70, the container 55 outer surface 60 also having an outer surface 60 perimeter 75, with the fluid 80 disposed therein the container interior 70, wherein the fluid 80 is heated.

The alternative embodiment 51 of the container apparatus includes the flexible elastomeric surrounding sidewall cover 310 that is about the longways axis 315 the flexible elastomeric surrounding sidewall cover 310 having a cover primary end portion 320 and an opposing cover secondary end portion 325 with the longways axis 315 spanning therebetween, the flexible elastomeric surrounding sidewall cover 310 further including a cover inner surface 330 and an opposing cover outer surface.

The alternative embodiment 51 of the container heating apparatus also includes the first flexible elastomeric surrounding sidewall 85 that is about the longitudinal axis 90, the first flexible elastomeric surrounding sidewall 85 having a first primary end portion 95 and an opposing first secondary end portion 100 with the longitudinal axis 90 spanning therebetween, the first flexible elastomeric surrounding sidewall 85 further including a first inner surface 105 and an opposing first outer surface 110, wherein the first outer surface 110 is affixed 340 to the cover inner surface 330, with the longitudinal 90 and the longways 315 axes being coincident 345 to one another.

The alternative embodiment 51 of the container heating apparatus further includes a reflective flexible elastomeric surrounding sidewall 350 that is about a lengthways axis 355, the reflective flexible elastomeric surrounding sidewall 350 having a reflective primary end portion 360 and an opposing reflective secondary end portion 365 with the lengthways axis 355 spanning therebetween. The reflective flexible elastomeric surrounding sidewall 350 further including a reflective inner surface 370 and an opposing reflective outer surface 375, wherein the reflective outer surface 375 is affixed 380 to the first inner surface 105, with the lengthways 355 and the longitudinal 90 axes being coincident 385 to one another.

Further included in the alternative embodiment 51 of the container heating apparatus is a flexible planar heating element 115 being formed into the second elastomeric surrounding sidewall 120 that is about the lengthwise axis 125, the second flexible elastomeric surrounding sidewall 120 having a second primary end portion 130 and an opposing second secondary end portion 135 with the lengthwise axis 125 spanning therebetween, the second flexible elastomeric surrounding sidewall 120 further including a second inner surface 140 and an opposing second outer surface 145. Wherein the second outer surface 145 is affixed 150 to the first inner surface 105 with the longitudinal 90 and the lengthwise 125 axes being coincident 155 to one another, wherein the second outer surface 145 is affixed 390 to the reflective inner surface 370 with the lengthways 355 and the lengthwise 125 axes being coincident 395 to one another.

Also included in the alternative embodiment 51 of the container heating apparatus is the third flexible elastomeric surrounding sidewall 160 that is about the longwise axis 165, the third flexible elastomeric surrounding sidewall 160 having a third primary end portion 170 and an opposing third secondary end portion 175 with the longwise axis 165 spanning therebetween. The third flexible elastomeric surrounding sidewall 160 further including the third inner surface 180 and the opposing third outer surface 185, wherein the third outer surface 185 is affixed 400 to the second inner surface 140 with the longwise 165 and the lengthwise 125 axes being coincident 405 to one another such that the cover 310, first 85, reflective 350, second 120, and third 160 elastomeric surrounding sidewalls form the alternative embodiment 51 of the container heating apparatus. Wherein operationally the third inner surface 180 is placed adjacent 200 to a portion of the container 55 outer surface 60 wherein the third inner surface 180 is manually positioned to partially encompass 205 a portion of the container 55 outer surface 60, see in particular FIGS. 7-9, 12, and 13.

As an option for the alternative embodiment 51 of the container heating apparatus, the cover outer surface 335 can further comprise the first means 210 for removable engagement and the third inner surface 180 further comprises the second means 215 for removable engagement, wherein the first 210 and second 215 means for removable engagement are removably mated 220 to one another to facilitate a partial overlap 410 of the third inner surface 180 in relation to the cover outer surface 335 to facilitate the container heating apparatus 50 to partially encompass 205 the container outer surface 60, see FIGS. 7-9, 12, and 13.

A further option for the alternative embodiment 51 of the container heating apparatus, the first 210 and second 215 means for removable engagement are both constructed of a hook and loop fastener 230 in the form of a first strip 235 for the first means 210 for removable engagement and a second strip 245 for the second means 215 for removable engagement. Wherein the first strip 235 has a first elongated axis 240 and the second strip 245 has a second elongated axis 250, wherein the first 240 and second 250 elongated axes are both substantially perpendicular 255 to the longwise axis 165. Further operationally, the first 235 and second 245 strips removably engage 260 one another such that the first 240 and second 250 elongated axes are substantially co-incident 265 to one another however, allowing selectable engagement 270 of the first 235 and second 245 strips along the first 240 and second 250 elongated axes to operationally accommodate a variable perimeter 76 of the container 55 outer surface 60 perimeter 75 to result in the third inner surface 180 being fully adjacent 295 to the container outer surface 60 with a variable overlap 415 of the third inner surface 180 on top of the cover outer surface 335.

Another option for the alternative embodiment 51 of the container heating apparatus, the flexible elastomeric surrounding sidewall cover 310 is preferably constructed of a flexible liquid proof material that is selected from the group consisting of vinyl, nylon, coated fabric, laminated fabric, synthetic fabric, polyester, polyurethane, oiled fabric, latex, rubber, waxed fabric, and polytetrafluoroethylene.

A further option for the alternative embodiment 51 of the container heating apparatus, the reflective flexible elastomeric surrounding sidewall 350 is preferably constructed of a reflective material that is selected from the group consisting of foil, foil mesh, mylar, silver, aluminum, aluminized fabric, cellophane, reflective paint on fabric, glass beads on fabric, PVC fabric, metalized film, and reflective vinyl.
50 Container Heating Apparatus
51 Alternative embodiment of the container heating apparatus
55 Container
60 Container outer surface
65 Container inner surface
70 Container interior
75 Outer surface 60 perimeter
76 Variable outer surface 60 perimeter
80 Fluid disposed within the container interior 70
85 First flexible elastomeric surrounding sidewall
90 Longitudinal axis of the first flexible elastomeric surrounding sidewall 85
95 First primary end portion of the first flexible elastomeric surrounding sidewall 85
100 First secondary end portion of the first flexible elastomeric surrounding sidewall 85
105 First inner surface of the first flexible elastomeric surrounding sidewall 85
110 First outer surface of the first flexible elastomeric surrounding sidewall 85
115 Flexible planar heating element
120 Second flexible elastomeric surrounding sidewall
125 Lengthwise axis of the second flexible elastomeric surrounding sidewall 120
130 Second primary end portion of the second flexible elastomeric surrounding sidewall 120
135 Second secondary end portion of the second flexible elastomeric surrounding sidewall 120
140 Second inner surface of the second flexible elastomeric surrounding sidewall
145 Second outer surface of the second flexible elastomeric surrounding sidewall
150 Affixed nature of the second outer surface 145 to the first inner surface 105
155 Coincident nature of the longitudinal 90 and lengthwise 125 axes
160 Third flexible elastomeric surrounding sidewall
165 Longwise axis of the third flexible elastomeric surrounding sidewall 160
170 Third primary end portion of the third flexible elastomeric surrounding sidewall 160
175 Third secondary end portion of the third flexible elastomeric surrounding sidewall 160
180 Third inner surface of the third flexible elastomeric surrounding sidewall 160
185 Third outer surface of the third flexible elastomeric surrounding sidewall 160
190 Affixed nature of the third outer surface 185 to the second inner surface 140
195 Coincident nature of the longwise 165 and lengthwise 125 axes
200 Adjacent nature of the third inner surface 180 to a portion of the container outer surface 60
205 Encompass in a partial manner of the third inner surface 180 to the portion of the container outer surface 60
210 First means for removable engagement
215 Second means for removable engagement
220 Removably mated nature of the first 210 and second 215 means for removable engagement
225 Partial overlap of the third inner surface 180 to the first outer surface 110 to facilitate the encompass in a partial manner 205 of the third inner surface 180 to the portion of the container outer surface 60
230 Hook and loop fastener of the first 210 and second 215 means for removable engagement
235 First strip of first 210 means for removable engagement
240 First elongated axis of the first strip 235
245 Second strip of second 215 means for removable engagement
250 Second elongated axis of the second strip 245
255 Substantially perpendicular position of the first 240 and second 250 axes to the longwise axis 165
260 Removable engagement of the first 235 and second 245 strips to one another
265 Coincident nature of the first 240 and second 250 elongated axes to one another
270 Selectable engagement of the first 235 and second 245 strips
280 Variable overlap of the third inner surface 180 to the first outer surface 110 to facilitate the encompass in a partial manner 205 of the third inner surface 180 to the portion of the container outer surface 60 to accommodate the variable perimeter 76 of the container outer surface 60
285 Recessed channel of the third inner surface 180
290 First plane that is formed across the third inner surface 180 and the second strip 245
295 Full contact or fully adjacent to the container outer surface 60 of the third inner surface 180 and the second strip 245
300 Serpentine electrical resistance heating element
305 Flexible backing sheet of the serpentine electrical resistance heating element being in the form of the second flexible elastomeric surrounding sidewall 120
310 Flexible elastomeric surrounding sidewall cover
315 Longways axis of the flexible elastomeric surrounding sidewall cover 310
320 Cover primary end portion of the flexible elastomeric surrounding sidewall cover 310
325 Cover secondary end portion of the flexible elastomeric surrounding sidewall cover 310
330 Cover inner surface of the flexible elastomeric surrounding sidewall cover 310
335 Cover outer surface of the flexible elastomeric surrounding sidewall cover 310
340 Affixed nature of the first outer surface 110 to the cover inner surface 330
345 Coincident nature of the longitudinal 90 and longways 315 axes
350 Reflective flexible elastomeric surrounding sidewall
355 Lengthways axis of the reflective flexible elastomeric surrounding sidewall
360 Reflective primary end portion of the reflective flexible elastomeric surrounding sidewall 350
365 Reflective secondary end portion of the reflective flexible elastomeric surrounding sidewall 350
370 Reflective inner surface of the reflective flexible elastomeric surrounding sidewall 350
375 Reflective outer surface of the reflective flexible elastomeric surrounding sidewall 350
380 Affixed nature of the reflective outer surface 375 to the first inner surface 105
385 Coincident nature of the longitudinal 90 and lengthways 355 axes
390 Affixed nature of the second outer surface 145 to the reflective inner surface 370
395 Coincident nature of the lengthwise 125 and lengthways 355 axes
400 Affixed nature of the third outer surface 185 to the second inner surface 140
405 Coincident nature of the longwise 165 and lengthwise 125 axes
410 Partial overlap of the third inner surface 180 to the cover outer surface 335 to facilitate the encompass in a partial manner 205 of the third inner surface 180 to the portion of the container outer surface 60
415 Variable overlap of the third inner surface 180 to the cover outer surface 335 to facilitate the encompass in a partial manner 205 of the third inner surface 180 to the portion of the container outer surface 60 to accommodate the variable perimeter 76 of the container outer surface 60

Accordingly, the present invention of the Container Heating Apparatus has been described with some degree of particularity directed to the embodiments of the present invention. It should be appreciated, though; that the present invention is defined by the following claims construed in light of the prior art so modifications or changes may be made to the exemplary embodiments of the present invention without departing from the inventive concepts contained therein.

1. A container heating apparatus to encompass a container with a container outer surface and an opposing container inner surface that defines a container interior the container outer surface also having an outer surface perimeter, with a fluid disposed therein the container interior, wherein the fluid is heated, said container heating apparatus comprising:
a. a first flexible elastomeric surrounding sidewall that is about a longitudinal axis, said first flexible elastomeric surrounding sidewall having a first primary end portion and an opposing first secondary end portion with said longitudinal axis spanning therebetween, said first flexible elastomeric surrounding sidewall further including a first inner surface and an opposing first outer surface;
b. a flexible planar heating element being formed into a second flexible elastomeric surrounding sidewall that is about a lengthwise axis, said second flexible elastomeric surrounding sidewall having a second primary end portion and an opposing second secondary end portion with said lengthwise axis spanning therebetween, said second flexible elastomeric surrounding sidewall further including a second inner surface and an opposing second outer surface, wherein said second outer surface is affixed to said first inner surface with said longitudinal and said lengthwise axes being coincident to one another; and
c. a third flexible elastomeric surrounding sidewall that is about a longwise axis, said third flexible elastomeric surrounding sidewall having a third primary end portion and an opposing third secondary end portion with said longwise axis spanning therebetween, said third flexible elastomeric surrounding sidewall further including a third inner surface and an opposing third outer surface, wherein said third outer surface is affixed to said second inner surface with said longwise and said lengthwise axes being coincident to one another such that said first, second, and third elastomeric surrounding sidewalls form said container heating apparatus, wherein operationally said third inner surface is placed adjacent to a portion of the container outer surface wherein said third inner surface is manually positioned to partially encompass a portion of the container outer surface.

2. A container heating apparatus according to claim 1, wherein said first outer surface further comprises a first means for removable engagement and said third inner surface further comprises a second means for removable engagement, wherein said first and second means for removable engagement are removably mated to one another to facilitate a partial overlap of said third inner surface in relation to said first outer surface to facilitate said container heating apparatus to partially encompass the container outer surface.

3. A container heating apparatus according to claim 2, wherein said first and second means for removable engagement are both constructed of a hook and loop fastener in the form of a first strip for said first means for removable engagement and a second strip for said second means for removable engagement, wherein said first strip has a first elongated axis and said second strip has a second elongated axis, wherein said first and second elongated axes are both substantially perpendicular to said longwise axis, wherein operationally said first and second strips removably engage one another such that said first and second elongated axes are substantially co-incident to one another however, allowing selectable engagement of said first and second strips along said first and second elongated axes to operationally accommodate a variable perimeter of the container outer surface perimeter to result in said third inner surface being fully adjacent to the container outer surface with a variable overlap of said third inner surface on top of said first outer surface.

4. A container heating apparatus according to claim 3 wherein said third inner surface further comprises a recessed channel that is adapted to receive said second strip such that a substantially flat first plane is formed across both said third inner surface and said second strip to operationally facilitate said third inner surface to fully contact the container outer surface adjacent to said second strip to increase heat transfer from said flexible planar heating element to the container outer surface.

5. A container heating apparatus according to claim 1 wherein said flexible planar heating element is constructed of a serpentine electrical resistance heating element supported by a flexible backing sheet to form said second elastomeric surrounding sidewall.

6. A container heating apparatus according to claim 5 wherein said first flexible elastomeric surrounding sidewall is constructed of a flexible thermally insulative material that is selected from the group consisting of open cell foam, closed cell foam, air pocket sheeting, fleece, silicone, ceramic fiber, polyester, nylon, cotton, muslin, rubber, butyl, wool, fiberglass, and synthetic fiber.

7. A container heating apparatus according to claim 6 wherein said third flexible elastomeric surrounding sidewall is constructed of a flexible thermally conductive material that is selected from the group consisting of metal mesh fabrics, metalized weaving yarns, flexible metals, graphene prints, and graphite film.

8. An alternate embodiment container heating apparatus to encompass a container with a container outer surface and an opposing container inner surface that defines a container interior the container outer surface also having an outer surface perimeter, with a fluid disposed therein the container interior, wherein the fluid is heated, said container heating apparatus comprising:
a. a flexible elastomeric surrounding sidewall cover that is about a longways axis said flexible elastomeric surrounding sidewall cover having a cover primary end portion and an opposing cover secondary end portion with said longways axis spanning therebetween, said flexible elastomeric surrounding sidewall cover further including a cover inner surface and an opposing cover outer surface;
b. a first flexible elastomeric surrounding sidewall that is about a longitudinal axis, said first flexible elastomeric surrounding sidewall having a first primary end portion and an opposing first secondary end portion with said longitudinal axis spanning therebetween, said first flexible elastomeric surrounding sidewall further including a first inner surface and an opposing first outer surface, wherein said first outer surface is affixed to said cover inner surface, with said longitudinal and said longways axes being coincident to one another;
c. a reflective flexible elastomeric surrounding sidewall that is about a lengthways axis, said reflective flexible elastomeric surrounding sidewall having a reflective primary end portion and an opposing reflective secondary end portion with said lengthways axis spanning therebetween, said reflective flexible elastomeric surrounding sidewall further including a reflective inner surface and an opposing reflective outer surface, wherein said reflective outer surface is affixed to said first inner surface, with said lengthways and said longitudinal axes being coincident to one another;
d. a flexible planar heating element being formed into a second elastomeric surrounding sidewall that is about a lengthwise axis, said second flexible elastomeric surrounding sidewall having a second primary end portion and an opposing second secondary end portion with said lengthwise axis spanning therebetween, said second flexible elastomeric surrounding sidewall further including a second inner surface and an opposing second outer surface, wherein said second outer surface is affixed to said reflective inner surface with said lengthways and said lengthwise axes being coincident to one another; and
e. a third flexible elastomeric surrounding sidewall that is about a longwise axis, said third flexible elastomeric surrounding sidewall having a third primary end portion and an opposing third secondary end portion with said longwise axis spanning therebetween, said third flexible elastomeric surrounding sidewall further including a third inner surface and an opposing third outer surface, wherein said third outer surface is affixed to said second inner surface with said longwise and said lengthwise axes being coincident to one another such that said cover, first, reflective, second, and third elastomeric surrounding sidewalls form said container heating apparatus, wherein operationally said third inner surface is placed adjacent to a portion of the container outer surface wherein said third inner surface is manually positioned to encompass a portion of the container outer surface.

9. A container heating apparatus according to claim 8, wherein said cover outer surface further comprises a first means for removable engagement and said third inner surface further comprises a second means for removable engagement, wherein said first and second means for removable engagement are removable mated to one another to facilitate a partial overlap of said third inner surface in relation to said cover outer surface to facilitate said container heating apparatus to partially encompass the container outer surface.

10. A container heating apparatus according to claim 9, wherein said first and second means for removable engagement are both constructed of a hook and loop fastener in the form of a first strip for said first means for removable engagement and a second strip for said second means for removable engagement, wherein said first strip has a first elongated axis and said second strip has a second elongated axis, wherein said first and second elongated axes are both substantially perpendicular to said longwise axis, wherein operationally said first and second strips removably engage one another such that said first and second elongated axes are substantially co-incident to one another however, allowing selectable engagement of said first and second strips along said first and second elongated axes to operationally accommodate a variable perimeter of the container outer surface perimeter to result in said third inner surface being fully adjacent to the container outer surface with a variable overlap of said third inner surface on top of said cover outer surface.

11. A container heating apparatus according to claim 10 wherein said third inner surface further comprises a recessed channel that is adapted to receive said second strip such that a substantially flat first plane is formed across both said third inner surface and said second strip to operationally facilitate said third inner surface to fully contact the container outer surface adjacent to said second strip to increase heat transfer from said flexible planar heating element to the container outer surface.

12. A container heating apparatus according to claim 8 wherein said flexible planar heating element is constructed of a serpentine electrical resistance heating element supported by a flexible backing sheet to form said second elastomeric surrounding sidewall.

13. A container heating apparatus according to claim 12 wherein said flexible elastomeric surrounding sidewall cover is constructed of a flexible liquid proof material that is selected from the group consisting of vinyl, nylon, coated fabric, laminated fabric, synthetic fabric, polyester, polyurethane, oiled fabric, latex, rubber, waxed fabric, and polytetrafluoroethylene.

14. A container heating apparatus according to claim 13 wherein said first flexible elastomeric surrounding sidewall is constructed of a flexible thermally insulative material that is selected from the group consisting of open cell foam, closed cell foam, air pocket sheeting, fleece, silicone, ceramic fiber, polyester, nylon, cotton, muslin, rubber, butyl, wool, fiberglass, and synthetic fiber.

15. A container heating apparatus according to claim 14 wherein said reflective flexible elastomeric surrounding sidewall is constructed of a reflective material that is selected from the group consisting of foil, foil mesh, mylar, silver, aluminum, aluminized fabric, cellophane, reflective paint on fabric, glass beads on fabric, PVC fabric, metalized film, and reflective vinyl.

16. A container heating apparatus according to claim 15 wherein said third flexible elastomeric surrounding sidewall is constructed of a flexible thermally conductive material that is selected from the group consisting of metal mesh fabrics, metalized weaving yarns, flexible metals, graphene prints, and graphite film.
